(19) United States
(12) Patent Application Publication
(10) Pub. No.: US 2002/0069056 A1
(43) Pub. Date: Jun. 6, 2002

(54) Methods and systems for generating documents from voice interactions

(76) Inventor: Charles Cole Nofsinger, New York, NY (US)

Correspondence Address: Dinsmore & Shohl LLP, 1900 Chemed Center, 255 East Fifth Street, Cincinnati, OH, 45202, US

(21) Appl. No.: 09/730,306

(22) Filed: Dec. 5, 2000

(51) Int. Cl. G10L 15/00

(52) U.S. Cl. 704/235

(57) ABSTRACT

Methods for peer to peer sharing of voice enabled document templates. One or more users are identified and a connection is established between the users. Users are assisted in identifying one or more voice enabled document templates and in displaying one or more of the templates between each other. Further, templates are identified on one or more computing devices and references to the templates recorded, with a listing of the references communicated to each of the computing devices. Moreover, a template associated with a first device is identified and displayed to a second device, where the template is used to interface with an audio device to generate a document.

### FIELD OF THE INVENTION

The present invention relates to methods for peer to peer sharing of voice enabled document templates.

### BACKGROUND OF THE INVENTION

Recent advances in technology are permitting better integration of voice driven data with computing device textual data. As voice recognition technologies and processing speeds of computing devices improve, this integration will become even more transparent. Presently, voice technology is being deployed to permit users to gain limited access to the World Wide Web (WWW) and the Internet. Audio interfaces are now capable of translating text to an audible word and capable of translating an audible word to an electronic text which may be associated with a computing device command used to perform a desired action on the computing device. In this way, individuals using telephones or mobile telephonic devices are capable of interacting with the WWW and the Internet in a limited manner. Several commercially available services have deployed these web based voice to text and text to voice technologies, for example TellMe™. TellMe™ uses extensible markup language (XML) to permit translation between voice and text.

However, some individuals engaged in professions or trades requiring extensive use of audio devices, such as Dictaphones, tape recorders, cell phones, telephones, mobile telephonic devices, interactive voice response devices (IVR), and the like, have not been able to effectively integrate and customize their existing electronic information with the existing technology. By way of example only, consider a surgeon who dictates into a audio recording device, the procedures he/she performs on a patient. The surgeon's dictation must comply with a myriad of governmental regulations and insurance mandates, if the surgeon ever expects to receive timely payment for his/her services.

Correspondingly, a surgeon will do an initial dictation which is then sent to a transcription agency, who transcribes the audio information into an electronic text format. The electronic text is then reviewed by trained office assistants at the surgeons office and edited, so that certain keywords are included in the dictation, keywords may then be associated with standardized codes which are required by governmental agencies and paying insurance companies of the patients.

These codes primarily correspond to two standards. The first standard of codes is referred to as Current Procedural Terminology (CPT) developed by the American Medical Association (AMA) and the Health Care Financing Administration (HCFA). The second standard of codes is referred to as the International Classification of Diseases 9th edition Clinical Modification (ICD9) developed by World Health Organization. These sets of codes are designed to standardize patient encounters, medical diagnoses, conditions and injuries, CPT codes are a national standard whereas the ICD9 codes are an international standard.

Existing software packages will generate the appropriate ICD9 and CPT codes based on the electronic text containing certain standard keywords present in the text. Moreover, some packages will generate the corresponding ICD9 codes for a given CPT code and vice versa. Office assistants often convert the surgeons keywords into more standard keywords recognizable by these packages, or the assistants will manually assign the ICD9 and CPT codes without the aid of software packages.

Yet, the required ICD9 or CPT codes often vary by procedure, and may vary from state to state, and from insurance company to insurance company. Accordingly, the entire process is cumbersome, manual, and fraught with human errors. The surgeons dictation must be matched to the mandated codes, if the surgeon ever expects to receive compensation for his/her services, and if he/she ever expects to maintain the right to receive governmental compensation for government insured patients, such as medicare and medicaid patients.

Often the procedures performed by a physician is straightforward, and dictation will proceed with a minimal amount of variation from patient to patient with any given procedure. Moreover, the parlance used by the surgeon is often learned by the physician's office assistance and readily associated with keywords or codes required by software packages or the governmental agencies and the insurance companies. This translation by the office assistant becomes largely mechanical, yet necessary, and adds to the overall expense in providing medical care to patients. The translation also becomes a learned trait based on the assistant's knowledge of the particular surgeon with which he/she is employed. As a result, the assistants become expensive and important resources for the surgeons.

Moreover, the transcription agencies are expensive and largely add little value to the overall dictation process other than providing transcription services to convert a surgeon's voice to text. Additionally, since a surgeon will use very technical terms in his/her dictation, the transcriptions are replete with mistakes and require many revisions before they are acceptable. Further, surgeons have little time to manually type their dictation and often find themselves giving dictation while driving, or while doing other activities, such as by way of example only, reviewing charts, walking within the hospital, and other activities.

These repetitive practices have not been automated to any significant degree, since the advances in technology have made the prospects of automation extremely unlikely. Previous efforts have focused on using strict voice recognition to convert audible words into electronic text, and have remained largely unsuccessful because even the best voice recognition technology cannot keep up with even the slowest paced conversation. Accordingly, using voice recognition technology is even more frustrating and time consuming for professions similar to a surgeon where multiple tasks must be performed at once, and where time is at a premium. Moreover, highly specialized words used extensively in the medical, legal, and science professions require specialized voice recognition technologies to successfully transcribe esoteric words to text, which do not typically comprise the vocabulary of standard voice recognition packages.

As a result, software vendors have developed a variety of specialized speech recognition packages to accommodate the highly specialized lexicons of various professions. Still, these packages cannot handle the normal rate at which individuals speak and are, therefore, not particularly attractive or useful to the very professionals who would find these packages useful. Moreover, even assuming these packages could transcribe voice to text at a reasonable rate, they are not capable of normalizing speech into required keywords or codes required in professions similar to the medical profession.

Furthermore, a voice to text and text to voice document generation system may be significantly enhanced if the knowledge associated with the development of any voice enabled template is readily shared with all the users of the system. In this way, users without the skills to develop voice enabled templates may utilize existing templates of other users who do have such knowledge. Moreover, users will be able to more quickly and rapidly be cable of utilizing the voice to text and text to voice document generation system if templates can be acquired easily and efficiently.

Technology has for some time permitted peer to peer connections between computing devices, all that is needed is an Internet Protocol (IP) address of each computing device, and direct connections may be readily established which permit any two computing devices to directly interface with each other using protocols such as TCP/IP, and others. More recently Classless Inter-Domain Routing (CIDR) has been used to route requests to domains wherein individual computing devices' addresses are resolved within the domain where a request is routed.

Moreover, direct peer to peer connections between computing devices may be established anonymously by each connecting computing device or in a centralized fashion. In a centralized facilitated peer to peer connection between computing devices, a centralized server locates the IP/CIDR addresses of the computing devices and connects the devices to one another. This approach permits the centralized server to track transactions occurring between the connected computing devices as well as other information regarding the computing devices, such as users associated with the devices, transmission rates of the devices, and other useful information.

With an anonymous connection, individual computing devices could directly connect to each other as long as an address is known, recent technology permits one user to use software which crawls the Internet and when appropriate criteria are met, such as a search query, the software facilitates a direct anonymous connection between the devices.

As one skilled in the art will readily appreciate, the ability to facilitate widespread peer to peer connections amongst users of a voice to text and text to voice document generation system would be of immense value since the knowledge required to create templates may be acquired by novice users, thereby making those novice users instantly productive and adept.

### SUMMARY OF THE INVENTION

Accordingly, an object of the invention is to provide methods for peer to peer sharing of voice enabled document templates By permitting users to subscribe to a voice to text and text to voice document management system, software may be provided where users may publish voice enabled document templates for other users to use. The publishing of these templates may be done by the document management system maintaining an index of users and templates, or it may be done anonymously amongst the users, or the document management system may warehouse the templates and distribute them as appropriate to the users. Moreover, transactions amongst the users may be trapped and recorded such that authors oftemplates receive a royalty associated with any acquired template. Further, the system may retain a transaction fee for facilitating any document template transfer or template displaying.

Additional objectives, advantages and novel features of the invention will be set forth in the description that follows and, in part, will become apparent to those skilled in the art upon examining or practicing the invention. The objects and advantages of the invention may be realized and obtained by means of the instrumentalities and combinations particularly pointed out in the appended claims. To achieve the foregoing and other objects and in accordance with the purpose of the present invention, methods for peer to peer sharing of voice enabled document templates are provided.

A method of electronically sharing voice to text templates for document generation is provided, comprising the executable instructions of identifying a first and a second user and establishing a peer to peer connection between the first and second users. Moreover, the users are assisted in identifying one or more voice enabled templates residing with each user. Further, the users are assisted in displaying one or more of the voice enabled templates between one another.

Furthermore, a method of indexing voice to text templates for document generation is provided, comprising the executable instructions of identifying one or more voice enabled templates on one or more computing devices and recording one or more references to the templates. A listing which includes the references is provided and the references are operable to be communicated to each of the computing devices.

Finally, a method of displaying a voice to text template for document generation is provided, comprising the executable instructions of identifying a first device with a first voice enabled text template and facilitating displaying of the template to the second device. The template is used to interface with an audio device to generate a document.

Still other aspects of the present invention will become apparent to those skilled in the art from the following description of an exemplary embodiment, which is by way of illustration, one of the exemplary modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 depicts a diagram of a peer to peer voice to text document sharing service;

FIG. 2 depicts a method of electronically sharing voice to text templates;

FIG. 3 depicts a method of indexing voice to text templates for peer to peer sharing;

FIG. 4 depicts a flow diagram of a method for displaying a voice to text template for document generation;

FIG. 5 depicts a voice enabled document template; and

FIG. 6 depicts a diagram of a voice to text document generation system.

### DETAILED DESCRIPTION

The present invention provides methods and systems for generating documents from voice interactions. One embodiment of the present invention is implemented in the Linux operating system environment using the PHP, C, and C++ programming language, against document templates written in XML format Of course other operating systems, programming languages, and data markup languages (now known or hereafter developed) may also be readily employed.

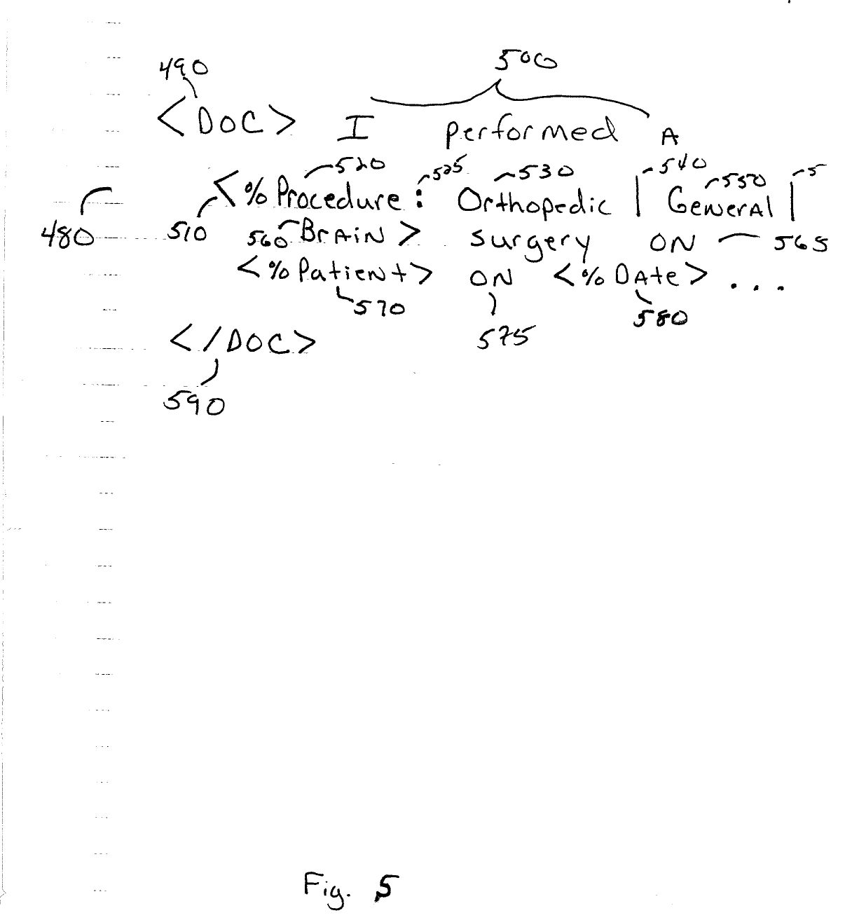

Initially, a document template is created, by way of example only, consider FIG. 5 where a document template 480 is defined by basic markup similar to markup dictated by XML standards, although as one skilled in the art will readily appreciate, any markup will suffice. The document templates begins with the “<DOC>” 490 tag and ends with the “</DOC> 590 tag. The strings “I performed a” 500, “surgery on” 565, and “on”575 are constant strings included within the template and will remain unchanged in any generated document being derived from document template 480. Moreover, constant strings will remain in the same order and sequence in any generated document as they appear in the document template 480. Further, constant strings need not be identified by data markup, although as one skilled in the art will appreciate they may be so identified for purposes of defining data presentation attributes in any generated document such as bolding, underlining, justification, and others. Additionally, structural or content based tags may be used to define some constant strings such as chapter, title, section, paragraph, and others as.

Special data markup strings beginning with “<%” will identify a special class of data included in the document template 480. For example, the strings “<% Procedure:” 520 and “<% Patient>” 570 may be identified as string labels which are detected by a substitution set of executable instructions because of the special string “<%”. Although, as one skilled in the art will readily appreciate any consistent data string will suffice. The substring following the “<%” string, which may be terminated by any non alphabetic character and is stripped by the substitution set of executable instructions and passed to an audio interface, such as by way of example only an interface provided by TellMe™, which uses standard voice XML server technology well known in the art, and other audio interfaces are available such that no particular audio interface is required with the present invention.

The audio interface will establish a voice interaction with a user, and ask the user to identify a template to perform substitution on, the user may identify by voice any template such as the template 480 in FIG. 5. Alternatively, the audio interface may read the names associated with each available template. Once the user selects a template for substitution, the audio interface will activate the template which will instruct the substitution set of executable instructions to be initiated, wherein each string label in the document template 480 will be detected and the special string (e.g. “<%”) stripped from the front end, and the terminating string (e.g. any non alphabetic character) stripped on the back end, thereby generating a substring which is passed to the audio interface and read to the user. For example, in FIG. 5 the string “<% Procedure:” will produce a substring “Procedure” which is then passed to the audio interface and read to the user. The reading of the word “Procedure” by the audio interface to the user prompts the user to input by voice the procedure which is to be performed.

Moreover, in FIG. 5 the string “<% Procedure: Orthopedic|General|Brain>” 510 includes a number of other options beyond what is described above for the string “<% Procedure” 520 which is a subset of string 510. For example, the “:” 525 following string 520 may be used as an indication to the substitution set of executable instructions that a variety of default string values are available and need to be parsed and passed to the audio interface for reading to the user. In document template 480, these options are delimited by the “|” 540 string, although as one skilled in the art will appreciate, any consistent markup string will suffice. Correspondingly, the strings “Orthopedic” 530, “General” 550, and “Brain” 560 are each passed to the audio interface and read to the user as options to select as values for the string label “Procedure”. The user may then speak the option of choice into the audio interface, and the audio interface provides the substitution set of executable instructions with the appropriate text word representative of the spoken word provided by the user.

Concurrent, with the interaction between the substitution set of executable instructions and the audio interface, the substitution set of executable instructions is generating a document from document template 480, and the responses received from the user during the audio dialogue which is transacting. The generated document, may be devoid of data markup, or may retain some level of data markup for purposes of being displayable in a variety of browsing or editing facilities. For example, the generated document could be provided in an Hypertext Markup Language (HTML) so that it could be viewed in a web browser, or in a native editor format such that it could be viewed or edited in an standard editor, such as by way of example only, Microsoft Word™. Although, as one skilled in the art will readily appreciate, a number of currently available editors, permit the viewing and editing of documents in native HTML, XML, and other data markups.

In any generated document, the substitution strings and the default values of strings are removed, with only the string constants and the values selected by the user remaining. Furthermore, some substitution strings may not provide any default values and may permit the user to speak what is desired as the default value without any additional assistance. For example, in document template 480, the substitution labels “<% Patient”>570 and “<% Date>” 580 will be parsed as described above, with the words “Patient” and “Date” individually read to user during the audio dialogue. The user will then speak what is desired to insert string values for the provided string labels. As one skilled in the art will appreciate, it is also possible to create string labels, which may permit a user to insert a value which may further trigger the substitution executable instructions to perform more complex operations, such as by way of example only, inserting large segments oftext referenced by a user supplied value, this would be similar to a file insert Moreover, different types of data may be inserted and associated with values, such that when a user selects a specific string value or provides a string value, additional information is inserted into the generated documents, such as by way of example only, raw electronic audio data, image data, video data, and association of codes such as CPT and ICD9 codes, as described above. In this way, more complex documents may be generated from relatively trivial document templates.

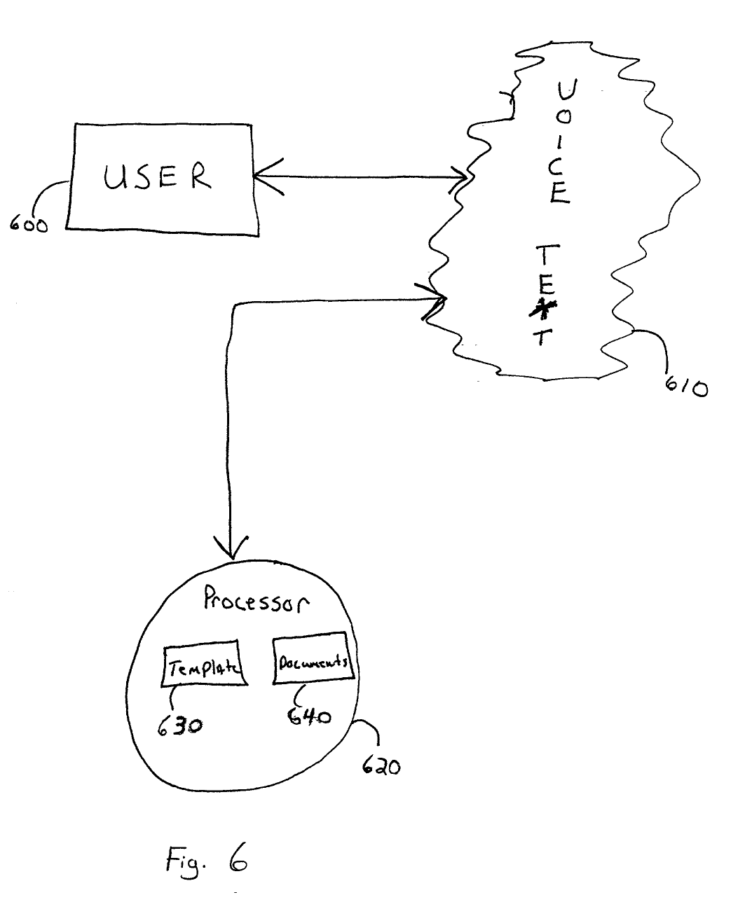

Referring to FIG. 6, which depicts one diagram of a voice to text document generation system. Templates 630 are created and stored on a processor 620 prior to any user 600 establishing a document generation audio dialogue with a voice to text interface 610. Templates 630 may be organized as described with the discussion of FIG. 6 above, and stored on a processor or in any external or internal computer readable medium (not shown in FIG. 6). Access to the template may be provided to a processor 620, which includes a set of executable instructions (not shown in FIG. 6) operable to interface with the templates 630 and the voice to text interface 610 to produce documents 640, as previously discussed.

Initially, a user 600 establishes an audio dialogue with a voice to text interface 610. Such interfaces are well known in the art and provide a circumscribed audio dialogue between a user 600 and a processor 620. The user 600 selects a template by voice, and the string labels included in the templates 630 are presented to the user 600 as spoken words. The user 600 proceeds to select string values or provide string values for each string label presented as spoken words. At the conclusion of the audio dialogue, a set of substitution values are combined with string constants in the originally selected template 630 to generate an electronic document 640, representative of the user's 600 dialogue with the voice to text interface 610.

By way of example only, consider a surgeon who wishes to dictate a recent surgical procedure on a patient. The surgeon uses a telephonic device to call the voice to text interface 610 and identifies himself to the interface 610, which prompts the interface 610 to ask in spoken words the surgeon which template he wishes to dictate. The surgeon speaks the name of the appropriate template 630 representative of his/her procedure on the patient and the interface 610 proceeds to communicate with a processor 620 wherein text labels and default values are passed to the interface 610. These labels are then translated to spoken words and presented to the surgeon. The surgeon responds with replacement values in spoken words, which are translated to electronic text by the interface 610 and provided to the processor 620. The processor 620, uses the appropriate executable instructions to convert a template 630 into a document 640 using the substitution values provided by the interface 610 which were initially received by the interface 610 from the surgeon as spoken words. At the conclusion of the interaction between the surgeon and the interface 610, a document 640 is created which represents the surgeon's dictation for his patient.

In this way, the resulting generated document includes appropriate keywords and CPT and ICD9 codes needed by the physician to timely receive compensation for his/her services from governmental agencies and insurance companies. Moreover, the surgeon did not have to endure one or more iterations with a transcription agency to ensure words he originally dictated were properly transcribed, and the surgeon only focused on the variable aspects of his procedure when he dictated through the interface 610. Therefore, the surgeon saved his/her own time by streamlining the dictation process. Furthermore, no specialized staff was required by the surgeon to ensure that keywords were mapped to the appropriate CPT and ICD9 codes, since the original template 630 included these substitutions automatically into the generated document 640 as the surgeon provided substitution values. Additionally, since the string constants in the template 630 remained the same in the generated document 640, the surgeon has started creating a data repository of dictation which is largely language consistent. This language consistency will permit many more automated operations to be performed on the surgeon's created documents since, as one skilled in the art will readily appreciate, processing becomes less complex when language consistency exists Moreover, document sharing between surgeons or other organizations becomes more easily achievable with language consistency.

Using the voice to text document management system and voice enabled document templates as presented above, users who register to interact with the system may substantially improve productivity by sharing document templates amongst themselves. Sharing of document templates may occur in a variety of ways, such as by way of example only, peer to peer connections facilitated through a centralized server affiliated with the voice to text document management system, peer to peer connections facilitated through anonymous connections, a data warehouse affiliated with the voice to text document management system, and others Moreover, transactions occurring with respect to document templates may be recorded such that authors of templates may be compensated for templates acquired and used, and the voice to text document management system may acquire transactional fees associated with the transfers or displays of the templates between users.

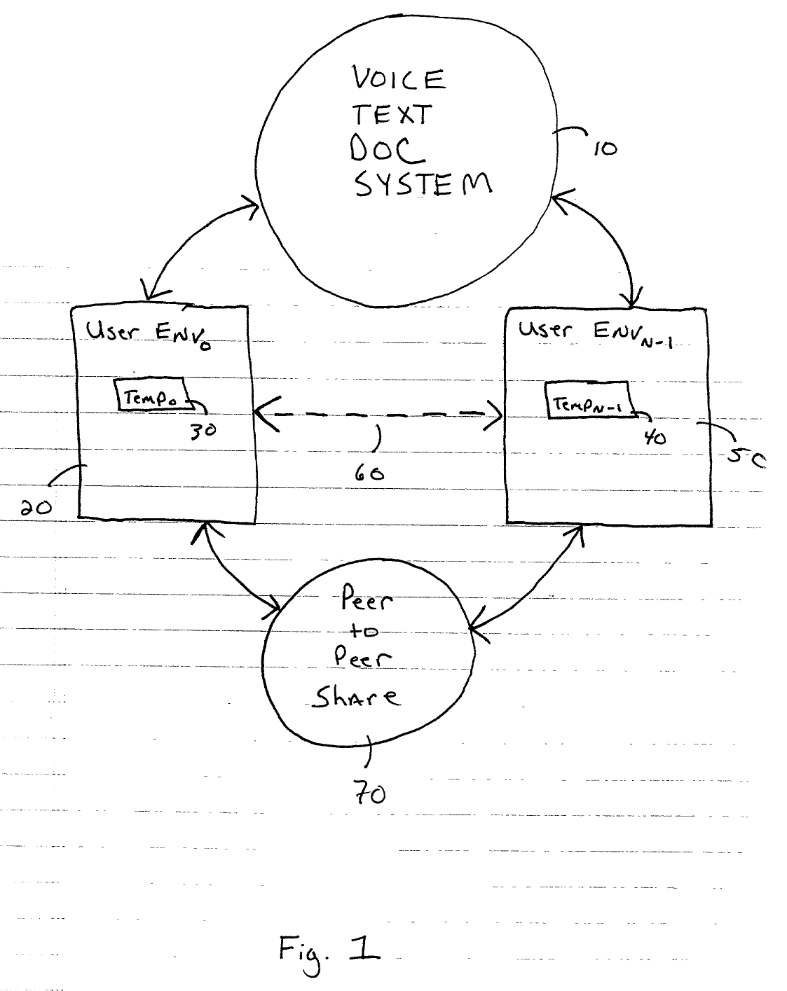

Consider FIG. 1, which depicts one diagram for a peer to peer voice to text document sharing service. Initially a voice to text document system 10, as previously described, identifies one or more users with each user environment 20 and 50 recorded. Users may register in any automated fashion with the service, such as by way of example only, telephone registration, regular mail registration, or electronic registration via the Internet, the WWW, and others. Once registered and signed onto the service depicted by FIG. 1, the address associated with a user's computing device may be acquired. This acquisition may be explicitly provided by the user, or acquired by the service since the user will have already implicitly provided this address when connecting to the service of FIG. 1. Each computing device associated with the users may include one or more voice enabled document templates as previously described.

For example, consider a first user connecting with the voice to text document system 10, the first user's computing device environment is identified by User Envo 20, with a first voice enabled document template Tempo residing within the device's computing environment. Moreover, a second user may connect with the voice to text document system 10, the second user's computing device environment is identified by User Envₙ₋₁ 50, the a second voice enabled document template Tempₙ₋₁ residing within the device's computing environment. Each user may elect to publish or register their voice enabled document templates with the voice to text document system 10.

Publication or registration of voice enabled document templates may occur in a variety or ways. By way of example only, a specific directory within a user's computing device's environment may be provided to the system 10, wherein the system will search for file names having apredefined extension, such as by way of example only, “vet” where “v” indicates voice, “e” indicates enabled, and “t” indicates template. Of course as one skilled in the art will appreciate, any consistent file naming technique would suffice. Moreover, the system could search for special tags within voice enabled templates rather than for specific file names. Additionally, users could upload specific templates to the system 10, where the system 10 warehouses the templates along with the relevant information as to which user provided the template. Furthermore, as one skilled in the art will readily appreciate, the user's computing device's environment may only include a reference to where a voice enabled template may be acquired, and the reference is operable to locate the voice enabled document. For example, the template could be physically stored on a web server, or another separate computing device from the user with the user's computing device environment including only a link to the physical location of the template.

Once the users have provided one or more templates or references to templates to the system 10, the system 10 may physically acquire the templates and index them for purposes of making terms within the templates available for searching and retrieval to all users of the system 10. Moreover, the system 10 may manually or automatically classify or organize the acquired templates or references to the templates into topical or hierarchical indexes, for purposes of allowing users to browse and traverse the topics or hierarchies to retrieve specific templates.

Lastly, the templates need not be physically stored in the system 10, rather, they may reside exclusively in each user's computing device's environment, either directly or indirectly by a reference link. In this way, the system 10 maintains only an index or references to the templates. The references may include, by way of example only, an address associated with a user's computing device and a location within the computing device's environment where the template resides, or may be acquired by further traversing a link. Although the system 10, need not maintain an index itself, the system 10 could simply facilitate individual searches of each user connect to the system to locate specific requested templates, or search queries associated with acquiring a template.

Furthermore, users may be directly connected to facilitate the peer to peer sharing 70 of voice enabled document templates. Peer to peer connections are well known in the art, and as previously discussed, these connections may occur by a centralized server such as through the system 10 depicted in FIG. 1, or the connections may be established directly between the users, with or without the aid of facilitating software. In the present example, the system 10 facilitates a peer to peer share 70 connection 60 between a first user and a second user. Once connected, the users may directly transfer or display voice enabled document templates between each other.

Further, the system may record any transfers or displays of templates occurring between the users, if a centralized peer to peer 70 connection 60 is being deployed. Recording the transfers or the displays of templates, will permit a number of accounting functions to be performed by the system 10, such as by way of example only, acquiring a fee from the user and acquiring a template and disbursing a royalty to the user providing a template Moreover, the system 10 may retain transactional fees associated with any transfer or display of a template occurring.

Optionally, these accounting functions may also be available with an anonymous peer to peer 70 connection 60, wherein a separate set of executable instructions are provided to each user desiring to have assistance in such a connection 60 In this way, the separate set of executable instructions would require payment from the user acquiring a template before permitting the transfer or the display of a template, and would anonymously send a transaction fee to the system 10, with the remaining fee going directly to the user providing the template. This anonymous peer to peer 70 connection 60 may be desirable by users who desire anonymity and privacy, yet software could still acquire a transaction fee for the system 10. Although as one skilled in the art will appreciate, no fee need collected at all, and no aiding software is needed at all if users directly connect to one another, yet if the users connect for purposes of facilitating the transfer or display of voice enabled documents, any such transfer or display falls within the scope of the present invention.

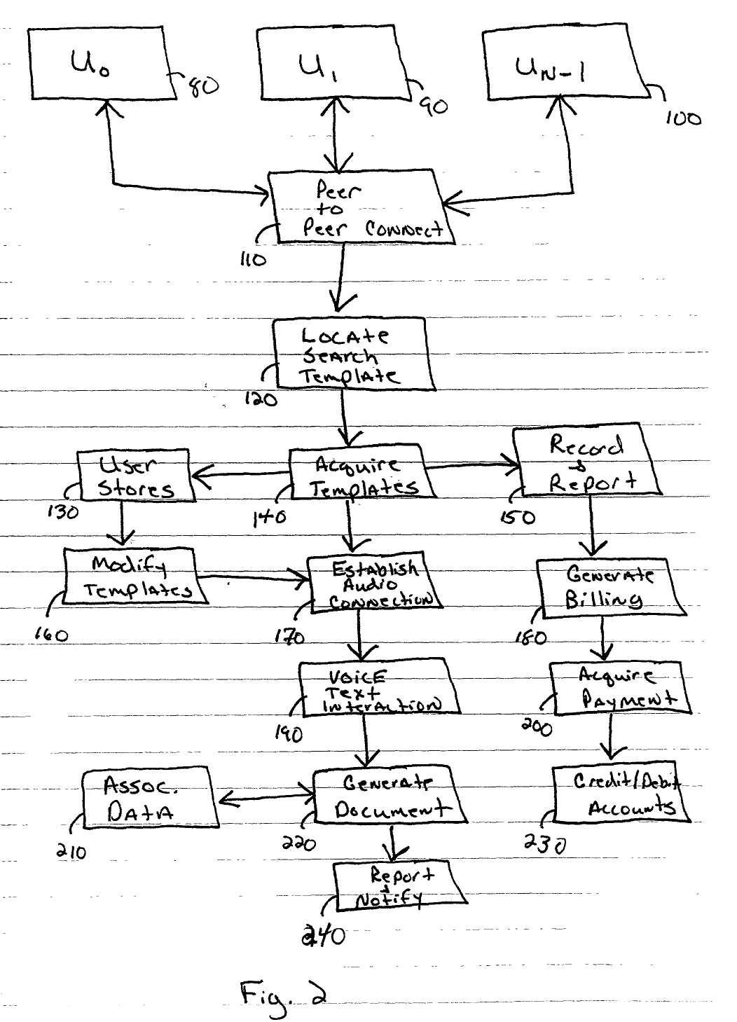

FIG. 2 depicts one method for electronically sharing voice to text templates. Initially one to many users are identified U₀ 80, U₁ 90, and Uₙ₋₁ 100 and communicate directly with one another via peer to peer connections in step 110. One or more of the users may then search for a template in step 120. Searching may occurring in variety of ways, such as by way of example only, searching each individual user's computing environment, searching an index on each individual user's computing environment, searching a voice to text document system as previously presented, searching an index located on a voice to text document system, browsing topics or hierarchies housed on each individual user's computing environment or located on a voice to text document system, and others.

Once a desired template is located, the template is acquired in step 140. Acquisition may also occur in a variety of ways, such as by way of example only, through software facilitating anonymous peer to peer connections, through centralized peer to peer connections facilitated by the voice to text document system, through delayed acquisition such as by an email order, an automated voice order, and others. After acquisition of the template occurs, the user stores or retains a reference to the template on the user's computing environment in step 130. Concurrently, the acquisition is recorded and reported to the voice to text document system in step 150. Once the user has the template, the template may be modified in step 160, to be customized or personalized to the individual needs of the user.

Moreover, the occurrence of a template transfer or template display may generate a billing event (step 180) within the voice to text document system, or within any software which helps facilitate anonymous peer to peer connections. Billing may further cause a payment to be acquired in step 200 from the acquiring user and any associated accounts may be appropriately credited or debited in step 230. For example, the voice to text document system may receive a credit for providing the transaction while the user who provided the template receives a royalty credit, in a similar way any account for the acquiring user is debited.

Once the acquiring user has a template and has modified it, if at all, the template is available for use within the voice to text document system, such that an audio connection may be established in step 170 with voice interactions occurring during that interaction in step 190, resulting in a unique instance of a document being generated in step 220. Further, the generated document may be associated with additional data, such as by way of example only, image, audio, video, and other types of data including additional templates incorporated by reference into the generated document.

After the document is generated, a report and notification may be sent to the user, to the owner of the template, to the owner of the original template, to the voice to text document system, and others. Moreover, the generated document may be electronically routed to any number of individuals, computing devices, electronic bulletin boards, telephonic devices, facsimiles, and other devices.

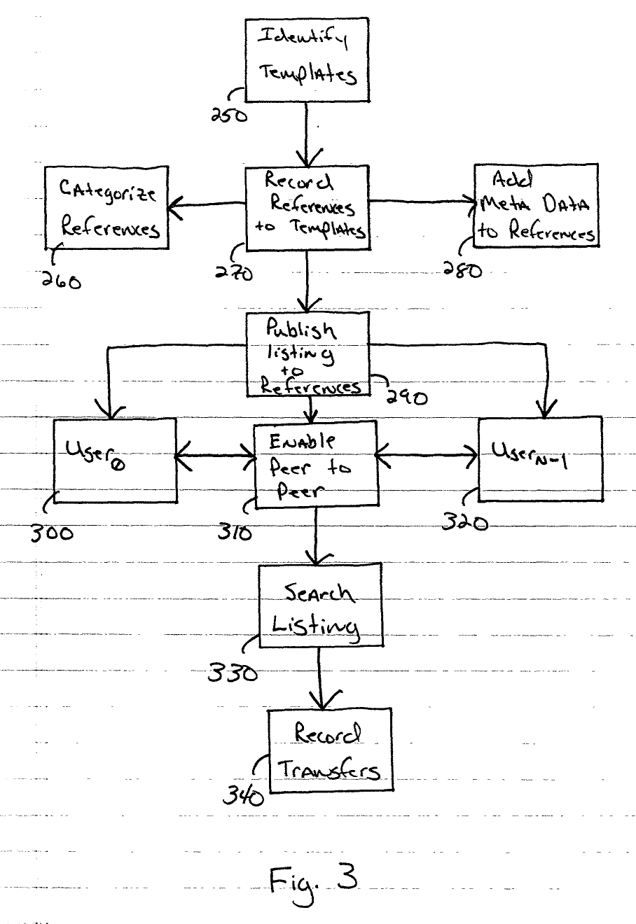

FIG. 3 depicts one method of indexing voice to text templates for peer to peer sharing. Templates are identified in step 250, identification may be by providing a reference to locate the template, providing the text of the template, providing search queries to locate templates, providing WWW crawlers to locate the templates, and others. Once identified, the location of the template or a reference to the location of the template is recorded in step 270. Further, additional meta data with respect to the identified templates may be associated with the recorded reference to the template in step 280. By way of example only, additional meta data may include, the name of the author of the template, an endorsing organization or individual associated with the template, the transfer rate associated with acquiring or downloading the template, any fee associated with acquiring the template, size in bytes associated with the template, version of the template, date last modified, and other attribute information.

Templates may be categorized in step 260 into topics and hierarchies as previously discussed. Moreover, the templates may be organized by author, by jurisdiction, by edit date, and other ways. Assembling the templates into logical groups, will facilitate better search and retrieval by the users. Further, these organizations, and the raw listings of the references to the templates, may be published in step 290. Publication provides the listing to one to many users (e.g. an identification of a first user in step 300 and a second user in step 320), who may or may not be engaged in peer to peer connections such as in step 330. The listing may be searched or browsed by the users in step 330, with any transfers or displays of templates being recorded in step 340.

As one skilled in the art will appreciate, the ability to index and warehouse, at least references to the templates, will provide a unique search and retrieval tool to users desiring to acquire voice enabled document templates. Moreover, any organization of the templates may be published in a variety of media, so that access to the templates becomes pervasive throughout the user community of the voice to text document system.

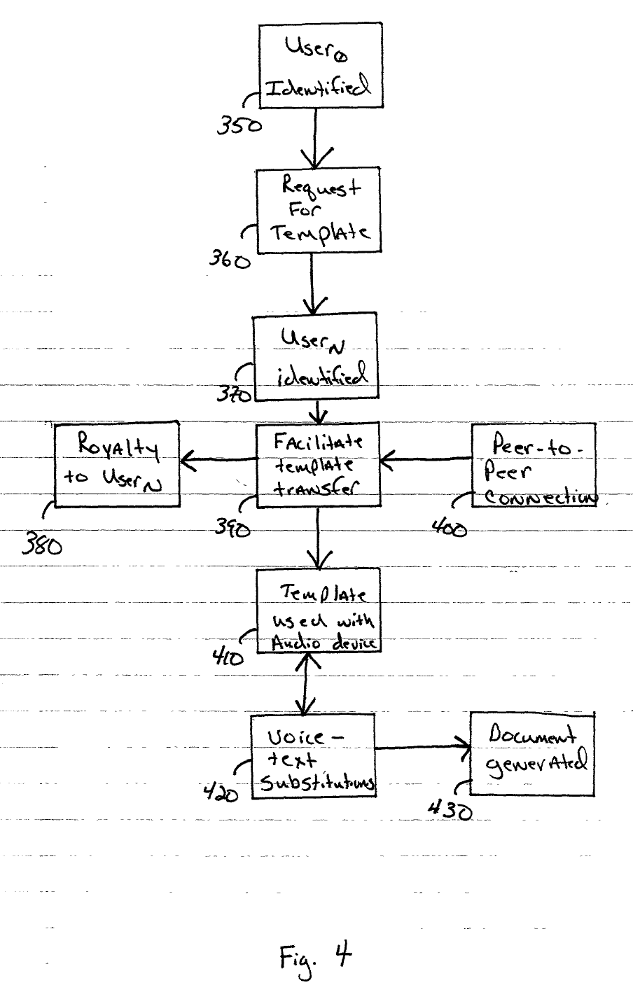

FIG. 4 depicts one flow diagram for a method of displaying or transferring a voice to text template for document generation. Initially, a first user is identified in step 350 by making a connection to a voice to text document system of the present invention, or by initiating an anonymous peer to peer connection using a facilitating set of executable instructions. The first user makes a request for a template in step 360, this request may be directly, by a search query, by browsing topics, or by browsing hierarchies. The template is located and is associated with a second user in step 370. In step 390, the first user is assisted in transferring the template from the second user. Although as one skilled in the art will readily appreciate, if the templates are accessed using techniques well known in the art such as, by way of example only, Active Server Pages (ASP), and if the templates are housed on a server, no transfer needs to occur at all since a local computer will merely display the templates. In these cases a transfer refers to the displaying of the template on a local computing device. Accordingly, displaying and transferring of templates are used interchangeably throughout this invention and are intended to fall within the purview of the present invention. The transfer may be by a peer to peer connection in step 400, this peer to peer connection may be through a centralized server or through anonymous connection. Further, if a voice to text document system is warehousing the template, the first user may not even need to be connected directly to the second user, rather, transfer or display of the template will occur with a connection from the first user to the voice to text document system.

In step 380, the second user may receive a royalty from the transfer or display. Likewise, the voice to text document system may retain a transaction fee associated with the transfer or display. Once the first user has the template, the template is interfaced with an audio device in step 410 where voice to text substitutions occur in step 420 and a unique instance of a document is generated in step 430 as a result of the substitutions occurring in step 420.

The foregoing description of an exemplary embodiment of the invention has been presented for purposes of illustration and description. It is not intended to be exhaustive nor to limit the invention to the precise form disclosed. Many alternatives, modifications, and variations will be apparent to those skilled in the art in light of the above teaching.

For example, the present invention need not be constrained to voice enabled templates, but may be deployed with video enabled templates, image enabled templates, plain text templates, or combinations of data type templates. In this way, users may share templates and construct templates though direct peer to peer interactions. Accordingly, this invention is intended to embrace all alternatives, modifications, and variations that fall within the spirit and broad scope of the attached claims.

What is claimed:

1. A method of electronically sharing voice to text templates for document generation, comprising the executable instructions of:
identifying a first and second user;
establishing a peer to peer connection between the first and second users;
assisting an identification of one or more voice enabled templates associated with the users; and
assisting in a display of one or more of the voice enabled templates between the users.

2. The method of claim 1, further comprising:
recording the display of each template as well as a recipient of each template and a transferor of each template.

3. The method of claim 2, further comprising:
collecting a fee from the recipient.

4. The method of claim 3, further comprising:
providing a royalty to the transferor.

5. The method of claim 4, further comprising:
retaining a transaction fee from the fee prior to providing the royalty.

6. The method of claim 1, wherein the voice enabled template is operable to interface with an audio device to generate a document from the template.

7. The method of claim 1, further comprising:
providing a directory listing of the templates to the users.

8. A method of indexing voice to text templates for document generation, comprising the executable instructions of:
identifying one or more voice enabled templates on one or more computing devices
recording one or more references to the templates; and
providing a listing which includes the references, wherein the references are operable to be communicated to each of the computing devices.

9. The method of claim 8, further comprising:
establishing a peer to peer connection between a first computing device and a second computing device for purposes of retrieving a remote voice enabled template using the listing.

10. The method of claim 8, further comprising:
associating meta data with each reference within the listing.

11. The method of claim 10, wherein the meta data includes at least one of a rating, an owner name, a transfer rate, and an edit date.

12. The method of claim 8, further comprising:
providing access to the listing to one or more authorized entities.

13. The method of claim 8, further comprising:
categorizing the listing by one or more subject matters.

14. The method of claim 8, further comprising:
permitting the computing devices to search the listing.

15. The method of claim 8, further comprising:
recording a transaction wherein one of the templates is displayed between the computing devices.

16. A method of displaying a voice to text template for document generation, comprising the executable instructions of:
identifying a first device with a first voice enabled template;
facilitating the displaying of the template to the second device; and
using the template to interface with an audio device to generate a document.

17. The method of claim 16, further comprising:
recording the displaying for purposes of at least one of a report and a billing.

18. The method of claim 6, further comprising:
replacing one or more text substitution strings with one or more text values converted when interfacing with the audio device, the text values inserted into the document.

19. The method of claim 16, where in the facilitation occurs by establishing a peer to peer connection between the devices.

20. The method of claim 16, further comprising:
providing a royalty associated with the first device after displaying to the second device.
